(19) United States
(12) Patent Application Publication
(10) Pub. No.: US 2021/0170509 A1
(43) Pub. Date: Jun. 10, 2021

(54) RECIPROCATING SAW

(71) Applicant: MILWAUKEE ELECTRIC TOOL CORPORATION, Brookfield, WI (US)

(72) Inventors: Beth E. Cholst, Wauwatosa, WI (US); Troy C. Thorson, Cedarburg, WI (US); Matthew R. Bailey, Racine, WI (US); Keith Boulanger, Kenosha, WI (US)

(21) Appl. No.: 17/117,878

(22) Filed: Dec. 10, 2020

Related U.S. Application Data
(60) Provisional application No. 62/946,067, filed on Dec. 10, 2019.

(51) Int. Cl. B23D 51/16; B23D 49/16

(52) U.S. Cl. CPC B23D 51/16; B23D 49/165; B23D 49/162

(57) ABSTRACT

A reciprocating saw includes a housing, a motor, and a drive assembly. The motor is positioned within the housing and includes a stator assembly with a stator body and a rotor assembly with a motor shaft and a rotor ring that surrounds the stator body. The rotor assembly is rotatable relative to the stator assembly about a motor axis. The drive assembly is positioned within the housing and coupled to the motor. The drive assembly includes a spindle configured to reciprocate along a tool axis that is perpendicular to the motor axis.

### CROSS-REFERENCE TO RELATED APPLICATIONS

This application claims priority to co-pending U.S. Provisional Patent Application No. 62/946,067, filed Dec. 10, 2019, the entire content of which is hereby incorporated by reference.

### FIELD OF THE INVENTION

The present invention relates to power tools, and more particularly reciprocating saws.

### BACKGROUND OF THE INVENTION

Reciprocating saws typically include a motor and a drive assembly. The motor includes a rotatable motor shaft that supplies torque to the drive assembly, and the drive assembly converts the rotational output of the motor shaft to a reciprocating output for the tool. Such reciprocating saws commonly include gear assemblies to adjust a gear ratio between the motor shaft and the drive assembly.

### SUMMARY OF THE INVENTION

The present invention provides, in one aspect, a reciprocating saw including a housing, a motor, and a drive assembly. The motor is positioned within the housing and includes a stator assembly with a stator body and a rotor assembly with a motor shaft and a rotor ring that surrounds the stator body. The rotor assembly is rotatable relative to the stator assembly about a motor axis. The drive assembly is positioned within the housing and coupled to the motor. The drive assembly includes a spindle configured to reciprocate along a tool axis that is perpendicular to the motor axis.

In another independent aspect, the present invention provides a reciprocating saw including a housing, a motor, and a drive assembly. The motor is positioned within the housing and includes a motor shaft rotatable about a motor axis. The drive assembly is positioned within the housing and includes a spindle and a crankshaft. The spindle is configured to reciprocate along a tool axis. The crankshaft is coupled to the motor shaft for rotation about the motor axis. The crankshaft includes a pin radially offset from the motor axis and coupled to the spindle to drive the spindle to reciprocate along the tool axis. The motor axis is perpendicular to the tool axis.

In another independent aspect, the present invention provides a reciprocating saw including a housing, a motor, and a drive assembly. The motor is positioned within the housing and includes a stator assembly and a rotor assembly rotatable about a motor axis relative to the stator assembly. The stator assembly includes a stator body with a central bore, and a stator mount having a mounting portion coupled to the housing. The stator mount also includes a supporting portion received within the central bore of the stator body, and a bearing mount portion coaxial with the supporting portion. The rotor assembly includes a motor shaft extending through the central bore and the supporting portion of the stator mount, a rotor ring that surrounds the stator body, and a bearing received within the bearing mount portion of the stator mount. One end of the motor shaft is rotationally supported by the bearing. the drive assembly is positioned within the housing. The drive assembly includes a spindle configured to reciprocate along a tool axis, and a crankshaft affixed to the motor shaft for co-rotation therewith about the motor axis. The crankshaft includes a crank pin radially offset from the motor axis and coupled to the spindle to drive the spindle to reciprocate along the tool axis. The motor axis is perpendicular to the tool axis.

Other features and aspects of the invention will become apparent by consideration of the following detailed description and accompanying drawings.

### BRIEF DESCRIPTION OF THE DRAWINGS

FIG. 1 is a perspective view of a reciprocating saw.

FIG. 2 is an exploded view of an electric motor of the reciprocating saw of FIG. 1.

FIG. 3 is a side view of the reciprocating saw of FIG. 1, with portions removed.

FIG. 4 is a side view of a prior art reciprocating saw.

FIG. 5 is a top view of the reciprocating saw of FIG. 1, with portions removed.

FIG. 6 is a top view of the prior art reciprocating saw of FIG. 4.

FIG. 7 is a perspective view of a further embodiment of the housing of the reciprocating saw of FIG. 2, with the housing transparent.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

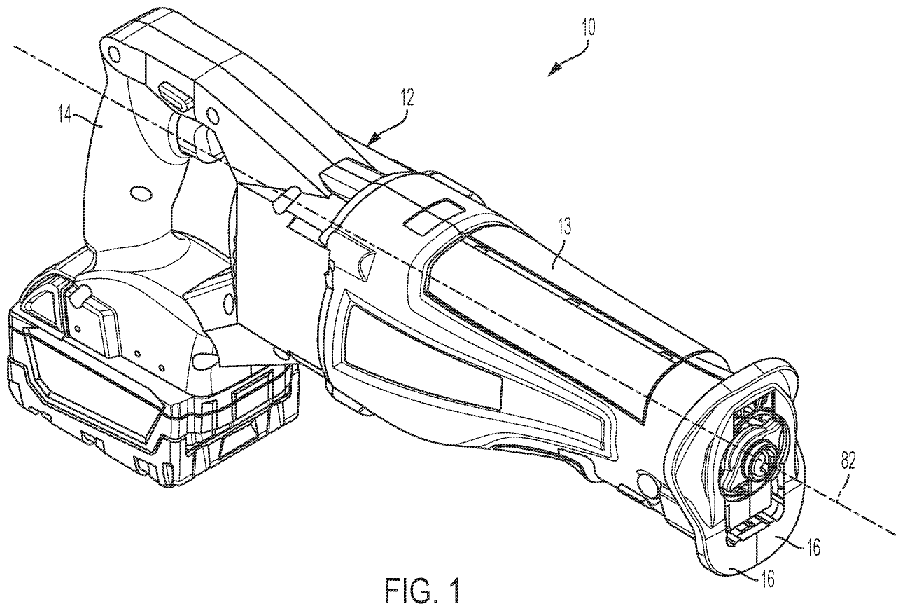

FIGS. 1-3 and 5 illustrate a power tool 10 according to an embodiment of the invention. The illustrated power tool 10 is a reciprocating saw 10 that is operable to drive a saw blade (not shown) in a reciprocating cutting motion. In the illustrated embodiment, the saw blade reciprocates along a tool axis 82. In other embodiments (not shown), the reciprocating saw 10 can be operable to drive the saw blade in an orbital or rocking cutting motion. The reciprocating saw 10 reciprocates the saw blade through a fixed stroke length (e.g., ¾″, 1⅛″, etc.). As will be discussed in further detail below, the reciprocating saw 10 is configured with a particular arrangement of components that provides for a shortened overall tool length.

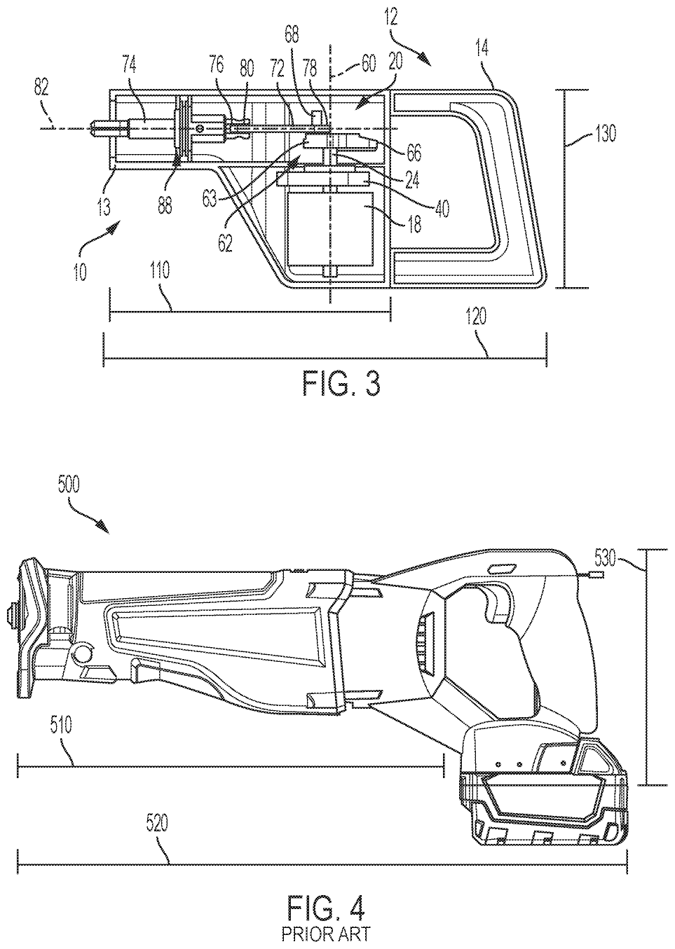

With reference to FIG. 1, the reciprocating saw 10 includes a housing 12 that defines a body 13 and a handle 14 extending rearward from the body 13. The housing 12 is formed by two clamshell halves 16. The reciprocating saw 10 also includes an electric motor 18 and a drive assembly 20 contained within the housing 12 (FIG. 3). As will be discussed below, the motor 18 and the drive assembly 20 are arranged within the housing 12 so as to provide for a shortened overall length of the reciprocating saw 10, as compared to typical known reciprocating saws.

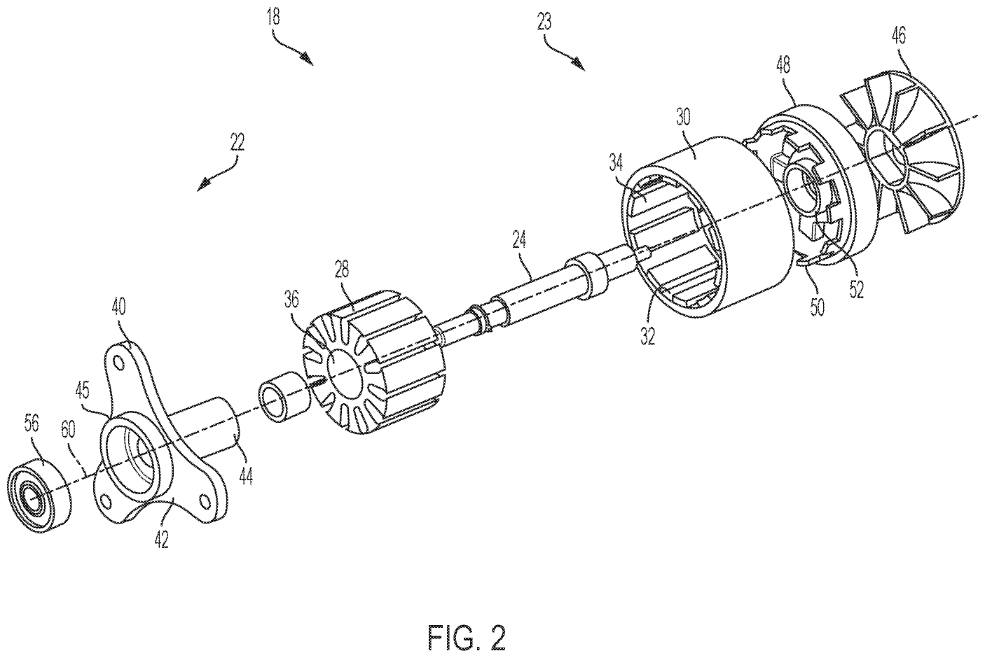

With reference to FIG. 2, the motor 18 includes a stator assembly 22 and a rotor assembly 23 rotatable relative to the stator assembly 22 about a motor axis 60. The illustrated motor 18 is an outer rotor motor 18. In this regard, the stator assembly 22 includes a centrally-located stator body 28, and the rotor assembly 23 includes a rotor ring 30 (in the shape of a cylindrical sleeve) that surrounds the stator body 28.

In addition to the rotor ring 30, the rotor assembly 23 includes a motor shaft 24, a fan 46, and an end cap 48 that affixes the rotor ring 30 to the motor shaft 24 for co-rotation therewith. The rotor ring 30 defines an inner surface 32, and the rotor ring 30 includes a plurality of magnets 34 affixed to the inner surface 32 and evenly spaced about a circumference thereof. The end cap 48 includes axially extending fingers 50 and a central hub 52. The axially extending fingers 50 extend into gaps between the magnets 34 and rotationally couple the end cap 48 to the rotor ring 30. The central hub 52 of the end cap 48 is affixed to the motor shaft 24, keeping the rotor ring 30 centered about the stator body 28. In the illustrated embodiment, the fan 46 is a separate component from the end cap 48 and is affixed to the motor shaft 24 for co-rotation therewith. In other embodiments (not shown), the fan 46 can be integrally formed with the end cap 48 rather than as a separate part.

In addition to the stator body 28, the stator assembly 22 includes a stator mount 40 having a mounting portion 42, a supporting portion 44, and a bearing mount portion 45 coaxial with the supporting portion 44. The stator body 28 includes a central bore 36 extending through the stator body 28, and windings (not shown) supported on the outside of the stator body 28. In assembly, the stator body 28 is affixed to the stator mount 40, and in turn, the stator mount 40 is fixedly supported within the housing 12. The supporting portion 44 is formed as a cylindrical sleeve that is received into the central bore 36 of the stator body 28 (e.g., by interference fit) to affix the stator body 28 to the stator mount 40. The motor shaft 24 extends through the central bore 36 of the stator body 28, and a radial bearing 56 is received into the bearing mount portion 45 and rotatably supports the motor shaft 24.

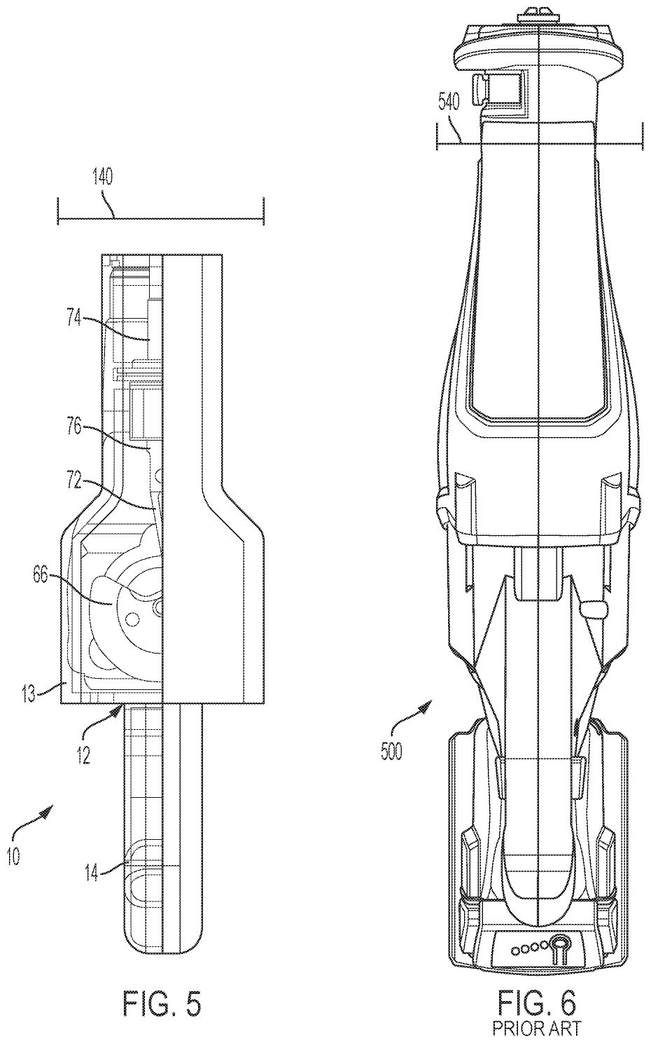

With reference to FIGS. 3 and 5, the drive assembly 20 is configured as a slider-crank drive assembly 20 that includes a crankshaft 62, a connecting rod 72, and a spindle 74. The crankshaft 62 includes a connecting portion 63 that supports a crank pin 68, and a counterweight portion 66 located generally opposite the connecting portion 63 with respect to the motor axis 60. The crankshaft 62 is affixed to the motor shaft 24 for co-rotation therewith. The crank pin 68 is radially offset from the motor axis 60 and extends parallel to the motor axis 60. The connecting rod 72 couples the crankshaft 62 to the spindle 74 and includes a first end 78 and a second end 80. The first end 78 is pivotably coupled to the crank pin 68. The second end 80 is pivotably coupled to a bracket portion 76 of the spindle 74. The reciprocating saw 10 also includes a bushing 88 supported within the housing 12, and the bushing 88 slidably supports the spindle 74 for reciprocation relative to the housing 12 along the tool axis 82. The spindle 74 is configured to reciprocate the saw blade (e.g., via a tool holder coupled to a distal end of the spindle 74 for removably supporting the saw blade; not shown).

In operation, upon activation of the motor 18, the rotor assembly 23 is caused to rotate about the motor axis 60 relative to the stator assembly 22. The rotation of the motor shaft 24 causes the crankshaft 62 to rotate about the motor axis 60, moving the crank pin 68 eccentrically around the motor axis 60. As the crank pin 68 moves about the motor axis 60, a component of the motion of the crank pin 68 parallel to the tool axis 82 is transmitted to the spindle 74 by the connecting rod 72, causing the spindle 74 to displace forward and backward along the tool axis 82. However, a component of the motion of the crank pin 68 perpendicular to the tool axis 82 is not communicated to the spindle 74. Therefore, the rotational motion of the motor shaft 24 about the motor axis 60 is converted into reciprocation of the spindle 74 along the tool axis 82.

By incorporating the outer rotor motor 18 in the reciprocating saw 10, the overall size of the reciprocating saw 10 is reduced as compared to a typical prior art reciprocating saw. The outer rotor motor 18 can operate at 3000 rpm and can output 90 in-lbs of torque. These operating characteristics enable the motor shaft 24 to directly supply torque (i.e., at a 1:1 ratio) to the drive assembly 20 to drive the reciprocation of the saw blade, without any transmission or gear reduction assembly coupled between the motor shaft 24 and the drive assembly 20. Therefore, the motor shaft 24 can directly interface with the crankshaft 62, negating the need for any additional components to adjust the gear ratio therebetween. This decreases the size and weight of the reciprocating saw 10 as compared to typical known reciprocating saws. The direct interface also allows the motor 18 to be arranged within the housing 12 such that the motor axis 60 is perpendicular to the tool axis 82. This further allows the motor 18 to be located below the crankshaft 62, further decreasing the length needed to house the saw components. It is contemplated that the benefits of the outer rotor motor 18 can also be achieved for other configurations of the drive assembly 20 (e.g., scotch yoke, wobble drive, etc.).

As illustrated in FIG. 3, the body 13 of the housing 12 has a body length 110 of 8.25 inches. The housing 12 has a full length 120, including the handle 14, of 13 inches. FIG. 4 illustrates a prior art reciprocating saw 500 that does not include an outer rotor motor arranged perpendicular to a tool axis, and that includes a transmission assembly. The prior art reciprocating saw 500 has a body length 510 of 12.5 inches, and a housing length 520 of the prior art saw is 17.25 inches. As shown in FIG. 3, the reciprocating saw 10 has a height 130 of 6 inches. FIG. 4 shows that the prior art reciprocating saw 500 has a height 530 of 6 inches. FIG. 5 shows that the reciprocating saw 10 has a width 140 of 3.75 inches. FIG. 6 shows that the prior art reciprocating saw 500 also has a width 540 of 3.75 inches.

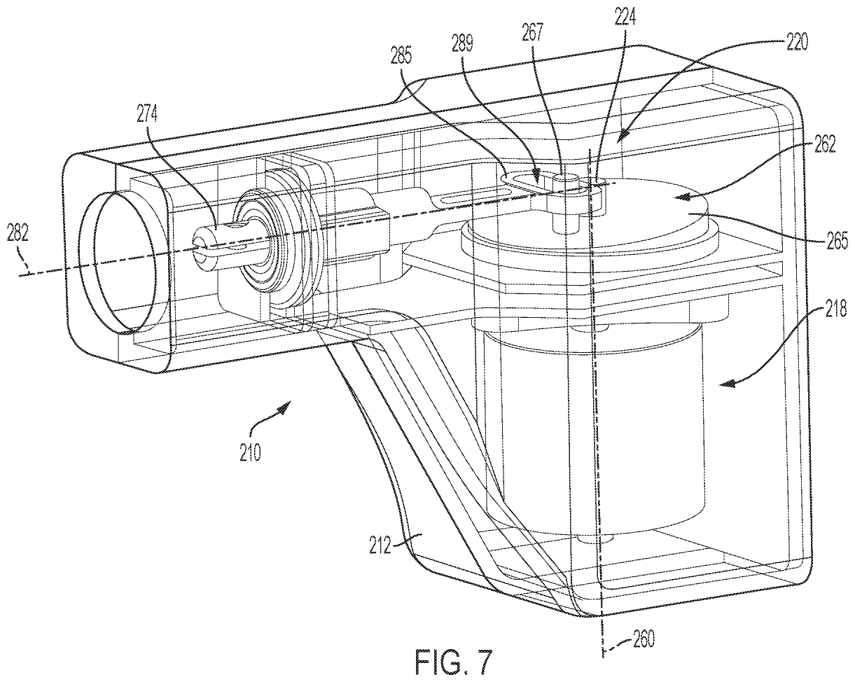

As referenced above, the reciprocating saw 10 can use alternate means for converting rotational motion of the motor shaft 24 to reciprocating motion of the saw blade. FIG. 7 illustrates a reciprocating saw 210 according to another embodiment of the invention. The reciprocating saw 210 includes a drive assembly 220 configured as a scotch-yoke drive assembly 220 rather than the crank-pin drive assembly 20 described above with respect to reciprocating saw 10. The reciprocating saw 210 is similar to the reciprocating saw 10 described above and includes much of the same structure as the reciprocating saw 10. Features and elements of the reciprocating saw 210 that are already described in connection with FIGS. 1-8 are numbered in the “200” series of reference numerals in FIG. 7. It should be understood that the features of the reciprocating saw 210 that are not explicitly described below have the same properties as the features of the reciprocating saw 10.

The reciprocating saw 210 includes a housing 212 that supports a motor 218 and the scotch yoke drive assembly 220. Like the motor 18 described above, the motor 218 is configured as an outer rotor motor 218 and includes a motor shaft 224 that defines a motor axis 260. The drive assembly 220 includes a crankshaft 262 and a spindle 274. The crankshaft 262 includes a plate 265 rotatably coupled to the motor shaft 224, and a crank pin 267 radially offset from the motor axis 260. The spindle 274 extends along a tool axis 282 and includes a slotted portion 285. The slotted portion 285 defines a slot 289 that extends generally perpendicular to both the motor axis 260 and the tool axis 282. The slot 289 receives the crank pin 267. The spindle 274 is slidably supported in the housing 212 for reciprocation relative to the housing 212 along the tool axis 282.

In operation, when the motor 218 is activated, the motor shaft 224 supplies torque to the crankshaft 262, causing the crank pin 267 to move eccentrically around the motor axis 260. The crank pin 267 travels along the slot 289 and drives the spindle 274 to reciprocate along the tool axis 282.

In other embodiments, in addition to the scotch-yoke and slider-crank mechanisms described herein, other drive trains can be used to convert the rotary motion of the outer rotor motor 18, 218 into linear reciprocation of the spindle 74, 274 (e.g. a wobble drive, etc.).

Various features of the disclosure are set forth in the following claims.

What is claimed is:

1. A reciprocating saw comprising:
a housing;
a motor positioned within the housing, the motor including
a stator assembly including a stator body, and
a rotor assembly rotatable about a motor axis relative to the stator assembly,
the rotor assembly including a motor shaft and a rotor ring that surrounds the stator body; and
a drive assembly positioned within the housing and coupled to the motor, the drive assembly including a spindle configured to reciprocate along a tool axis;
wherein the motor axis is perpendicular to the tool axis.

2. The reciprocating saw of claim 1, wherein the rotor assembly further includes an end cap that affixes the rotor ring to the motor shaft for co-rotation therewith, and a plurality of magnets affixed to an inner surface of the rotor ring.

3. The reciprocating saw of claim 1, wherein the drive assembly further includes a crankshaft affixed to the motor shaft.

4. The reciprocating saw of claim 3, wherein the drive assembly further includes a connecting rod having a first end pivotably coupled to the crankshaft and a second end pivotably coupled to the spindle to translate rotational motion of the crankshaft to reciprocating motion of the spindle.

5. The reciprocating saw of claim 3, wherein the crankshaft includes a crank pin radially offset from the motor axis, and the spindle includes a slot that receives the crank pin.

6. The reciprocating saw of claim 1, wherein the motor shaft directly supplies torque to the drive assembly at a 1:1 ratio.

7. The reciprocating saw of claim 1, wherein the motor is positioned below the tool axis.

8. The reciprocating saw of claim 1, wherein the housing extends along the tool axis between a forward end and a rear end to define a length therebetween, the length being 13 inches or less.

9. A reciprocating saw comprising:
a housing;
a motor positioned within the housing, the motor including a motor shaft rotatable about a motor axis; and
a drive assembly positioned within the housing, the drive assembly including
a spindle configured to reciprocate along a tool axis, and
a crankshaft coupled to the motor shaft for rotation about the motor axis, the crankshaft including a crank pin radially offset from the motor axis and coupled to the spindle to drive the spindle to reciprocate along the tool axis;
wherein the motor axis is perpendicular to the tool axis.

10. The reciprocating saw of claim 9, wherein the motor includes a stator assembly having a stator body, and a rotor assembly rotatable about the motor axis relative to the stator assembly, the rotor assembly including a rotor ring that surrounds the stator body.

11. The reciprocating saw of claim 10, wherein the rotor assembly further includes an end cap that affixes the rotor ring to the motor shaft for co-rotation therewith, and a plurality of magnets affixed to an inner surface of the rotor ring.

12. The reciprocating saw of claim 9, wherein the drive assembly further includes a connecting rod having a first end pivotably coupled to the crank pin and a second end pivotably coupled to the spindle to translate rotational motion of the crankshaft to reciprocating motion of the spindle.

13. The reciprocating saw of claim 9, wherein the spindle includes a slot that receives the crank pin.

14. The reciprocating saw of claim 9, wherein the motor shaft directly supplies torque to the drive assembly at a 1:1 ratio.

15. The reciprocating saw of claim 9, wherein the motor is positioned below the tool axis.

16. The reciprocating saw of claim 9, wherein the housing extends along the tool axis between a forward end and a rear end to define a length therebetween, the length being 13 inches or less.

17. A reciprocating saw comprising:
a housing;
a motor positioned within the housing, the motor including
a stator assembly including
a stator body with a central bore, and
a stator mount having a mounting portion coupled to the housing, a supporting portion received within the central bore of the stator body, and a bearing mount portion coaxial with the supporting portion, and
a rotor assembly rotatable about a motor axis relative to the stator assembly, the rotor assembly including
a motor shaft extending through the central bore and the supporting portion of the stator mount,
a rotor ring that surrounds the stator body, and
a bearing received within the bearing mount portion of the stator mount, one end of the motor shaft being rotationally supported by the bearing; and
a drive assembly positioned within the housing, the drive assembly including
a spindle configured to reciprocate along a tool axis, and
a crankshaft affixed to the motor shaft for co-rotation therewith about the motor axis, the crankshaft including a crank pin radially offset from the motor axis and coupled to the spindle to drive the spindle to reciprocate along the tool axis;
wherein the motor axis is perpendicular to the tool axis.

18. The reciprocating saw of claim 17, wherein the drive assembly further includes a connecting rod having a first end pivotably coupled to the crank pin and a second end pivotably coupled to the spindle to translate rotational motion of the crankshaft to reciprocating motion of the spindle.

19. The reciprocating saw of claim 17, wherein the spindle includes a slot that receives the crank pin.

20. The reciprocating saw of claim 17, wherein the motor is positioned below the tool axis.
